(19) United States
(12) Patent Application Publication
(10) Pub. No.: US 2022/0201362 A1
(43) Pub. Date: Jun. 23, 2022

(54) ARTIFICIAL INTELLIGENCE AND MACHINE LEARNING EVALUATION OF ELEMENTS IN RENDERED VIDEO

(71) Applicant: T-Mobile USA, Inc., Bellevue, WA (US)

(72) Inventor: David Plug, Littleton, CO (US)

(21) Appl. No.: 17/126,866

(22) Filed: Dec. 18, 2020

(51) Int. Cl. H04N 21/475; G06K 9/34; H04N 21/462

(52) U.S. Cl. CPC H04N 21/4756; G06K 2209/01; H04N 21/462; G06K 9/344

(57) ABSTRACT

One or more devices use artificial intelligence and machine learning to evaluate elements in rendered video. The one or more devices may perform a method for evaluating video content that includes the operations of: obtaining a rendered version of the video content using a processor; capturing a frame of the rendered version of the video content using the processor; detecting an element in the frame using the processor using a set of characteristics that distinguishes the element from other elements; and generating an evaluation using the processor by comparing the element detected in the frame to a specification for the element in the video content.

### FIELD

The described embodiments relate generally to evaluating video. More particularly, the present embodiments relate to artificial intelligence and machine learning evaluation of elements in rendered video.

### BACKGROUND

Video content provided by cable, satellite, terrestrial broadcast, streaming, and/or other content providers may include additional elements and/or other data beyond the original video content (such as one or more television programs, sporting events, commercials, movies, shows, and so on that may include any kind of visual and/or audio data) provided to such content providers by one or more content sources. For example, content providers may provide video content that includes the original video content and/or a version thereof, such as a compressed and/or otherwise processed version of the original video content, along with code and/or other instructions to present other elements along with the original content.

Such other elements may include one or more closed captioning elements (such as title 6 closed captioning), subtitle elements, emergency broadcast elements, channel and/or other numbers, channel and/or network and/or other logos and/or icons, interactive elements, electronic program guides, menus and/or other interactive elements, and so on. The video content provided by a content provider may be received by one or more content access devices that render the video content for presentation, such as via one or more integrated and/or external display devices and/or other output devices.

Content providers may test the video content to ensure that the additional elements have been included as intended. Typically, one or more human beings may watch a presentation of the rendered video content and look for the various additional elements to ensure that they appear as intended. The human beings may generate reports that may be used to adjust the video content and/or one or more processes and/or devices used to generate the video content.

### OVERVIEW

The present disclosure relates to using artificial intelligence and machine learning to more accurately identify elements in presented video content. In some examples, tools may be used to interrogate back end code to find interactive elements as opposed to on-screen display. This may find what is intended to be present rather than what actually ends up being present, which may not be the same. The code may specify to generate interactive elements that do not get generated and are thus irrelevant because they cannot actually be seen and/or interacted with. Instead, actual on-screen display may be analyzed to visually and/or conceptually recognize interactive elements in the on-screen display. In some examples, a capture card may be used to locally interrogate a video signal. Artificial intelligence/machine learning may then be used to process the locally captured video signal in order to recognize what is actually on the screen and enhance that recognition with artificial intelligence/machine learning. A camera may capture the screen instead, though screen capture eliminates the possibility of glare. This may be used to evaluate aspects of generated video, such as the quality of closed captioning or subtitles, the electronic programming guide, video (artifacts from compression), and so on. This may also be done to identify interactive elements to have automation testing interact with when designing automation testing scripts.

In various embodiments, a method for evaluating video content includes obtaining a rendered version of the video content using a processor, capturing a frame of the rendered version of the video content using the processor, detecting a polygon of a text element in the frame using the processor, masking the polygon using the processor, detecting text of the polygon after the masking using the processor via optical character recognition, and generating a readability and accuracy score for the text using the processor using a comparison of the text to a reference. In some examples, detecting the polygon of the text element in the frame using the processor includes determining whether the polygon includes a single color background.

In a number of examples, detecting the polygon of the text element in the frame using the processor includes determining whether the polygon includes contrasting text color inside the polygon. In various examples, detecting the polygon of the text element in the frame using the processor includes determining whether a color of the polygon holds consistent while a background changes. In some examples, detecting the polygon of the text element in the frame using the processor includes evaluating a position of the polygon in the frame. In a number of examples, detecting the polygon of the text element in the frame using the processor includes determining whether the polygon is a rectangle that includes multiple rectangles.

In various examples, the text element is at least one of a closed captioning element, a subtitle element, or an electronic program guide element. In some examples, the reference is at least one of closed captioning data associated with the video content, a library, or a dictionary. In a number of examples, the readability and accuracy score is based at least on one of a percentage of incorrectly defined characters or a font size.

In some embodiments, a method for evaluating video content includes obtaining a rendered version of the video content using a processor, capturing a frame of the rendered version of the video content using the processor, detecting an element in the frame using the processor using a set of characteristics that distinguishes the element from other elements, and generating an evaluation using the processor by comparing the element detected in the frame to a specification for the element in the video content. In various examples, the rendered version of the video content is obtained via a video capture card.

In a number of examples, the method further includes using the element to determine a channel associated with the frame. In some examples, the method further includes using the element to determine that the frame is associated with a commercial. In a number of implementations of such examples, the element is at least one of a channel logo, a network logo, or a closed captioning element.

In various examples, the evaluation includes placement of an icon or a logo. In a number of examples, the evaluation indicates a video quality resulting from compression. In various examples, the rendered version of the video content is obtained via an image sensor.

In a number of embodiments, a method for evaluating video content includes obtaining a rendered version of the video content using a processor, capturing a frame of the rendered version of the video content using the processor, and detecting an interactive element in the frame using the processor using a set of characteristics that distinguishes the interactive element from other elements. In some examples, the method further includes generating a testing script using the interactive element detected in the frame. In various implementations of such examples, the method further includes testing the video content using the testing script.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for artificial intelligence and machine learning evaluation of elements in rendered video.

FIG. 2 depicts an example of one or more video processing and evaluation devices that may be used in the system of FIG. 1.

FIG. 3 depicts a flow chart illustrating a first example method for artificial intelligence and machine learning evaluation of elements in rendered video. This method may be performed by the system of FIG. 1 and/or the video processing and evaluation device of FIG. 2.

FIG. 4 depicts a flow chart illustrating a second example method for artificial intelligence and machine learning evaluation of elements in rendered video. This method may be performed by the system of FIG. 1 and/or the video processing and evaluation device of FIG. 2.

FIG. 5 depicts a first example frame of video content.

FIG. 6 depicts a second example frame of video content.

FIG. 7 depicts a flow chart illustrating a third example method for artificial intelligence and machine learning evaluation of elements in rendered video. This method may be performed by the system of FIG. 1 and/or the video processing and evaluation device of FIG. 2.

FIG. 8 depicts a third example frame of video content.

FIG. 9 depicts a flow chart illustrating a fourth example method for artificial intelligence and machine learning evaluation of elements in rendered video. This method may be performed by the system of FIG. 1 and/or the video processing and evaluation device of FIG. 2.

FIG. 10 depicts a fourth example frame of video content.

FIG. 11 depicts a fifth example frame of video content.

FIG. 12 depicts a flow chart illustrating a fifth example method for artificial intelligence and machine learning evaluation of elements in rendered video. This method may be performed by the system of FIG. 1 and/or the video processing and evaluation device of FIG. 2.

FIG. 13 depicts a flow chart illustrating a sixth example method for artificial intelligence and machine learning evaluation of elements in rendered video. This method may be performed by the system of FIG. 1 and/or the video processing and evaluation device of FIG. 2.

FIG. 14 depicts a flow chart illustrating a seventh example method for artificial intelligence and machine learning evaluation of elements in rendered video. This method may be performed by the system of FIG. 1 and/or the video processing and evaluation device of FIG. 2.

FIG. 15 depicts a flow chart illustrating an eighth example method for artificial intelligence and machine learning evaluation of elements in rendered video. This method may be performed by the system of FIG. 1 and/or the video processing and evaluation device of FIG. 2.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Testing may be very important in many situations. In some examples, missing elements and/or elements not appearing as intended may result in an inferior video product that may damage reputation and/or business. In other examples, missing elements and/or elements not appearing as intended may be a violation of law (such as missing closed captioning elements), breach of contract, and so on. As such, failure to test and/or adequately test video content may have significant consequences.

As the amount of video content to verify and the amount of additional elements included in such video content grows increasingly larger, using human beings to verify the additional elements becomes increasingly time consuming, costly, burdensome, error prone, and so on. Automated testing may reduce time, cost, effort, and/or errors for such verification, but it may be challenging to configure automated testing devices to verify the additional elements in video content as previously performed by human beings.

Artificial intelligence and machine learning may be used to configure automated testing devices to verify the additional elements in video content. Artificial intelligence may refer to the use and/or development of computing devices and/or systems that are able to perform tasks normally associated with human intelligence, such as visual perception (including reading text; identifying faces, places, objects, and so on; recognizing video quality; identifying and locating elements on a screen; identifying what is being watched via channel number and/or logo and/or other characteristic; searching for something to watch such as using a graphical interface; distinguishing between programs and commercials; and so on), speech recognition, decision-making, translation between languages, and so on. Machine learning may refer to the use and/or development of computing devices and/or systems that are able to learn and adapt without following explicit instructions, such as by using algorithms and/or statistical models to analyze and draw inferences from patterns in data. Through artificial intelligence and machine learning, computing devices and/or other devices and/or systems may be configured to read text; identify faces, places, objects, and so on; recognize video quality; identify and locate elements on a screen; identify what is being watched via channel number and/or logo and/or other characteristic; search for something to watch such as using a graphical interface; distinguish between programs and commercials; and so on.

As one example, tools may be used to interrogate code and/or other instructions associated with video content to identify and/or analyze one or more additional elements indicated therein. However, this may find what is intended to be present rather than what actually ends up being present, which may not be the same.

Instead, video content may be rendered for presentation and artificial intelligence and/or machine learning may be used to process the rendered version of the video content. This may find what actually ends up being present rather than what is intended to be present. The rendered version of the video content may be obtained via one or more video capture cards and/or other components and/or other mechanisms, via one or more cameras and/or other image sensors configured to capture the output of one or more displays (though this may involve the possibility of glare that may be eliminated by the video capture card implementation), and so on.

Artificial intelligence and machine learning may be used to process the rendered version of the video content to identify elements expected to be present in the rendered version of the video content and/or to generate an evaluation (and/or used to adjust the video content and/or one or more processes and/or devices used to generate the video content) based on the elements identified. In some examples, elements may be identified using a set of characteristics that distinguishes those elements from other elements. In various examples, the identified elements may be evaluated according to a specification for elements in the video content.

In this way, computing devices and/or other electronic devices and/or systems may be configured to use artificial intelligence and machine learning, verify video content, and/or perform other functions that the computing devices and/or other electronic devices and/or systems were not previously able to perform. Further, the computing devices and/or other electronic devices and/or systems may be configured to perform such functions more accurately and reliably with fewer errors in such a manner as is less time consuming, costly, burdensome, error prone, and so on than the use of human beings for video content verification. Additionally, such configuration of the computing devices and/or other electronic devices and/or systems may be more efficient than previous automated video content verification techniques and, as such, may reduce required hardware and/or software resources and/or consumption of such hardware and/or software resources, as well as eliminating hardware and/or software resources that are no longer needed.

The following disclosure relates to using artificial intelligence and machine learning to more accurately identify elements in presented video content. In some examples, tools may be used to interrogate back end code to find interactive elements as opposed to on-screen display. This may find what is intended to be present rather than what actually ends up being present, which may not be the same. The code may specify to generate interactive elements that do not get generated and are thus irrelevant because they cannot actually be seen and/or interacted with. Instead, actual on-screen display may be analyzed to visually and/or conceptually recognize interactive elements in the on-screen display. In some examples, a capture card may be used to locally interrogate a video signal. Artificial intelligence/machine learning may then be used to process the locally captured video signal in order to recognize what is actually on the screen and enhance that recognition with artificial intelligence/machine learning. A camera may capture the screen instead, though screen capture eliminates the possibility of glare. This may be used to evaluate aspects of generated video, such as the quality of closed captioning or subtitles, an electronic programming guide, video (artifacts from compression), and so on. This may also be done to identify interactive elements to have automation testing interact with when designing automation testing scripts.

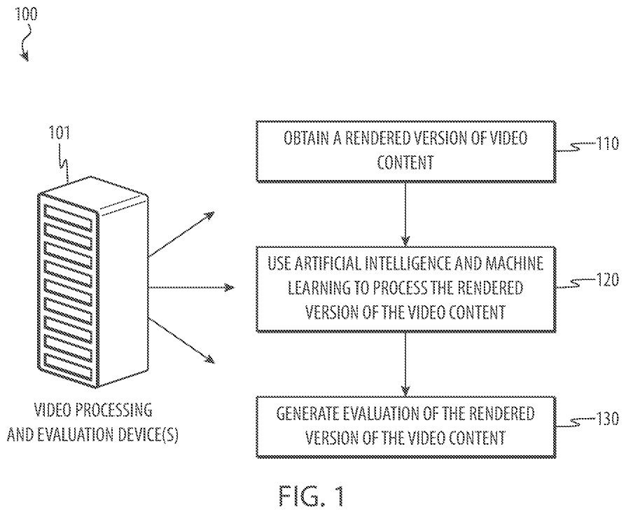

These and other embodiments are discussed below with reference to FIGS. 1-15. However, those skilled in the art will readily appreciate that the detailed description given herein with respect to these Figures is for explanatory purposes only and should not be construed as limiting.

FIG. 1 depicts an example system 100 for artificial intelligence and machine learning evaluation of elements in rendered video. The system 100 may include one or more video processing and evaluation device(s) 101.

At 110, the video processing and evaluation device 101 may be operable to obtain a rendered version of video content. At 120, the video processing and evaluation device 101 may be operable to use artificial intelligence and machine learning to process the rendered version of the video content. At 130, the video processing and evaluation device 101 may be operable to generate an evaluation of the rendered version of the video content.

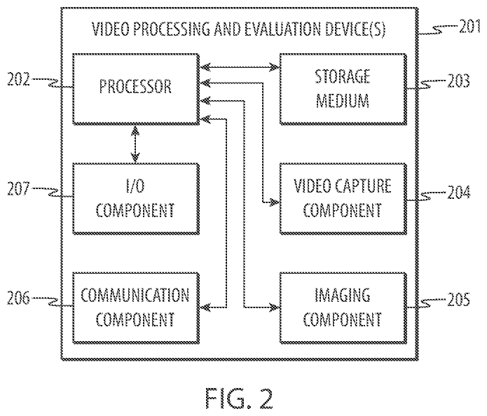

FIG. 2 depicts an example of one or more video processing and evaluation devices 201 that may be used in the system 100 of FIG. 1. The video processing and evaluation device 201 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on.

The video processing and evaluation device may include one or more processors 202 and/or other processing units and/or controllers, one or more non-transitory storage media 203 (which may take the form of, but is not limited to, a magnetic storage medium; optical storage medium; magneto-optical storage medium; read only memory; random access memory; erasable programmable memory; flash memory; and so on), one or more video capture components 204 (such as one or more Magewell Capture cards and/or other video capture cards and/or other components), one or more imaging components 205 (such as one or more cameras and/or other image sensors), one or more communication components 206, one or more input and/or output components 207 (such as one or more displays, keyboards, mice, touch screens, touch pads, computer mice, track pads, speakers, microphones, printers,), and/or other components. The processing unit may execute instructions stored in the non-transitory storage medium to perform various functions. Such functions may include obtaining a rendered version of video content, using artificial intelligence and machine learning to process the rendered version of the video content (such as by using tools such as OpenCV tools), generating an evaluation of the rendered version of the video content, and so on.

Although the system 100 is illustrated and described as including particular components arranged in a particular configuration, it is understood that this is an example. In a number of implementations, various configurations of various components may be used without departing from the scope of the present disclosure.

For example, the system 100 is illustrated and described as including both the video capture component 204 and the imaging component 205. However, it is understood that this is an example. In various implementations, the system 100 may include one of these components while omitting the other. Various configurations are possible and contemplated without departing from the scope of the present disclosure.

Returning to FIG. 1, the video processing and evaluation device 101 may use the video processing and evaluation device 101 to perform a variety of difference functions. Such functions may be involved in processing the rendered version of the video content, generating the evaluation, and so on. Through artificial intelligence and machine learning, computing devices and/or other devices and/or systems may be configured to read text; identify faces, places, objects, and so on; recognize video quality; identify and locate elements on a screen; identify what is being watched via channel number and/or logo and/or other characteristic; search for something to watch such as using a graphical interface; distinguish between programs and commercials; and so on.

The video processing and evaluation device 101 may use artificial intelligence and machine learning to process the rendered version of the video content to identify elements expected to be present in the rendered version of the video content and/or generate an evaluation (and/or used to adjust the video content and/or one or more processes and/or devices used to generate the video content) based on the elements identified. In some examples, the video processing and evaluation device 101 may identify elements using a set of characteristics that distinguishes those elements from other elements. In various examples, the video processing and evaluation device 101 may evaluate the identified elements according to a specification for elements in the video content.

In this way, the video processing and evaluation device 101 may be configured to use artificial intelligence and machine learning, verify video content, and/or perform other functions that the video processing and evaluation device 101 was not previously able to perform. Further, the video processing and evaluation device 101 may be configured to perform such functions more accurately and reliably with fewer errors in such a manner as is less time consuming, costly, burdensome, error prone, and so on than the use of human beings for video content verification. Additionally, such configuration of the video processing and evaluation device 101 may be more efficient than previous automated video content verification techniques and, as such, may reduce required hardware and/or software resources and/or consumption of such hardware and/or software resources, as well as eliminating hardware and/or software resources that are no longer needed.

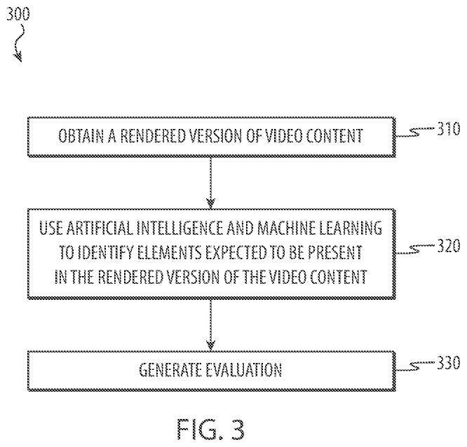

FIG. 3 depicts a flow chart illustrating a first example method 300 for artificial intelligence and machine learning evaluation of elements in rendered video. This method 300 may be performed by the system 100 of FIG. 1 and/or the video processing and evaluation device 201 of FIG. 2.

At operation 310, an electronic device (such as the video processing and evaluation device 101, 201 of FIGS. 1 and/or 2) may obtain a rendered version of video content. The electronic device may obtain the rendered version of the video content using a video capture component to capture the video content upon rendering for presentation on one or more displays and/or other presentation components, a camera and/or other imaging device to capture presentation of the video content on one or more displays, and so on.

At operation 320, the electronic device may use artificial intelligence and machine learning to identify elements expected to be present in the rendered version of the video content. For example, the electronic device may identify elements using a set of characteristics that distinguishes those elements from other elements. By way of another example, the electronic device may identify elements by attempting to locate elements indicated in the code and/or other instructions included with the video content. In yet another example, the electronic device may identify elements by attempting to locate elements indicated in a specification of elements intended to be included in the video content. Such a specification may indicate the elements that are intended to be present, time and/or position locations of where the elements are intended to be, intended characteristics of the elements, and so on.

At operation 330, the electronic device may generate an evaluation. The electronic device may generate the evaluation by comparing the identified elements to those expected to be present. By way of example, the electronic device may evaluate the identified elements according to a specification for elements in the video content. Such a specification may indicate the elements that are intended to be present, time and/or position locations of where the elements are intended to be, intended characteristics of the elements, and so on.

In various examples, this example method 300 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 300 is illustrated and described as including particular operations performed in a particular order, it is understood that this is an example. In various implementations, various orders of the same, similar, and/or different operations may be performed without departing from the scope of the present disclosure.

For example, operation 320 is illustrated and described in the context of identifying elements expected to be present. However, it is understood that this is an example. In various implementations, the electronic device may identify elements in the rendered version of the video content without reference to any expectations regarding elements to be present. Various configurations are possible and contemplated without departing from the scope of the present disclosure.

Further, operation 310 is illustrated and described in the context of obtaining the rendered version of the video content. However, it is understood that this is an example. In various implementations, the electronic device may render the video content rather than obtaining the rendered version of the video content. Various configurations are possible and contemplated without departing from the scope of the present disclosure.

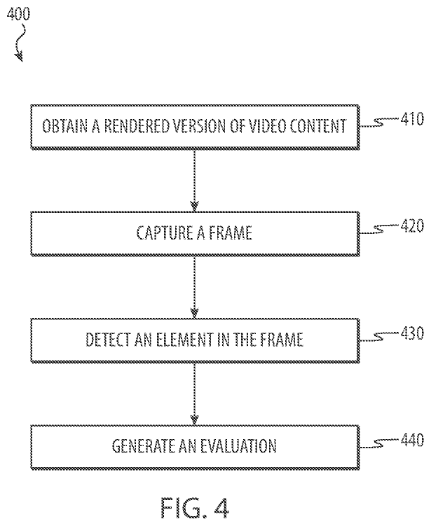

FIG. 4 depicts a flow chart illustrating a second example method 400 for artificial intelligence and machine learning evaluation of elements in rendered video. This method 400 may be performed by the system 100 of FIG. 1 and/or the video processing and evaluation device 201 of FIG. 2.

At operation 410, an electronic device (such as the video processing and evaluation device 101, 201 of FIGS. 1 and/or 2) may obtain a rendered version of video content. At operation 420, the electronic device may capture a frame of the rendered version of video content. However, although operation 410 is discussed in the context of a frame of the rendered version of the video content, it is understood that this is an example. In various implementations, other portions of the rendered version of the video content may be used instead of a frame without departing from the scope of the present disclosure.

At operation 430, the electronic device may detect an element in the frame. The element may include one or more closed captioning elements, subtitle elements, emergency broadcast elements, channel and/or other numbers, channel and/or network and/or other logos and/or icons, interactive elements, electronic program guides, menus and/or other interactive elements, and so on.

At operation 440, the electronic device may generate an evaluation. The evaluation may generate a score. Such a score may be generated according to whether or not the element and/or other elements are present, whether or not the element and/or other elements are positioned where intended in time and place with respect to the video content, the element and/or other elements appear as intended, whether or not the element and/or other elements are readable (such as whether or not the element and/or other elements are presented at a sufficient size and clarity to be viewed by people with between 20/10-20/40 visual acuity at a distance of approximately 1-20 feet) and/or accurate, and so on.

In various examples, this example method 400 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 may include one or more additional operations. By way of illustration, in some implementations, the method 400 may include the additional operation of the electronic device adjusting (and/or signaling one or more other devices to adjust) the video content and/or one or more processes and/or devices used to generate the video content. The electronic device may adjust (and/or signal one or more other devices to adjust) the video content and/or one or more processes and/or devices used to generate the video content based on and/or otherwise using the evaluation. By way of another illustration, the method 400 may include the additional operation of modifying a set of characteristics used to distinguish between an element and other elements based on differences identified by the electronic device between the element and other elements while processing the video content. Various configurations are possible and contemplated without departing from the scope of the present disclosure.

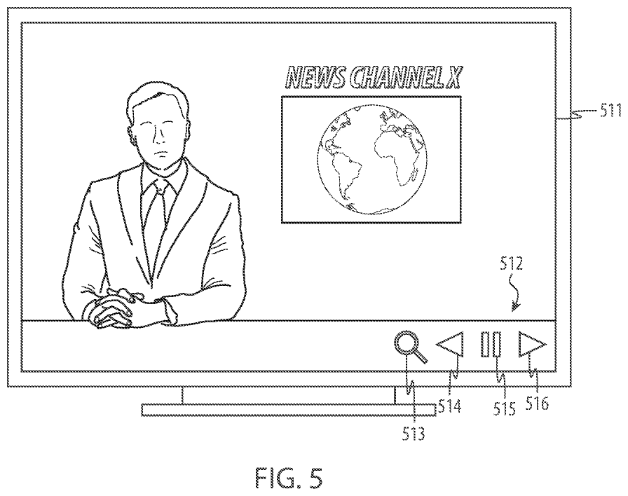

FIG. 5 depicts a first example frame 511 of video content. The frame 511 may include a number of interactive elements 512. The interactive elements 512 may include a search element 513, a rewind element 514, a pause element 515, and a cue element 516. The methods 300, 400 of FIGS. 3-4 (and/or one or more of the other methods discussed herein) may be used to process the frame 511 to identify one or more of the interactive elements 512 and/or generate one or more evaluations.

In some examples, such an evaluation may be used to adjust (and/or signal one or more other devices to adjust) the video content and/or one or more processes and/or devices used to generate the video content. In other examples, the evaluation may be used to generate a testing script involving one or more of the interactive elements 512 that may be used to test the video content.

By way of illustration, the frame 511 may be processed to identify one or more of the interactive elements 512 using a set of characteristics that distinguishes one or more of the interactive elements 512 from each other and/or other elements. By way of another illustration, the frame 511 may be processed to identify one or more of the interactive elements 512 using a specification that indicates the position in time and space with respect to the video content where the interactive elements 512 are intended to appear. In yet another illustration, the evaluation may score whether or not the interactive elements 512 appear at the position in time and space with respect to the video content where the interactive elements 512 are intended to appear. Various configurations are possible and contemplated without departing from the scope of the present disclosure.

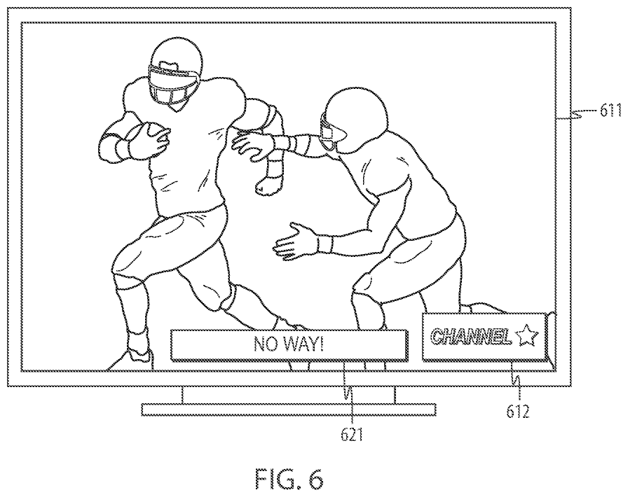

FIG. 6 depicts a second example frame 611 of video content. The frame 611 may include a channel logo 612 and a text element 621 (such as a closed captioning element, a subtitle element, and so on). The methods 300, 400 of FIGS. 3-4 (and/or one or more of the other methods discussed herein) may be used to process the frame 611 to identify one or more of the channel logo 612 and/or the text element 621 and/or generate one or more evaluations.

By way of illustration, the frame 611 may be processed to identify one or more of the channel logo 612 and the text element 621 using a set of characteristics that distinguishes one or more of the channel logo 612 and the text element 621 from each other and/or other elements. For example, the set of characteristics may indicate that the channel logo 612 is intended to be positioned at the bottom right of the frame 611 whereas the text element 621 is intended to be positioned at the middle right of the frame 611. However, it is understood that this is an example and that other configurations are possible and contemplated without departing from the scope of the present disclosure.

Detection of the channel logo 612 may be used as part of channel detection (i.e., detecting a channel associated with a frame of video), channel change detection (i.e., detecting that a portion of a video content is associated with a change from one channel to another), and so on. Channel change detection may include detecting a number of indicators. Another example of such an indicator beyond the channel logo 612 may include detecting a black screen with contrasting text appearing in a corner that indicates a new channel and program title. Various configurations are possible and contemplated without departing from the scope of the present disclosure.

By way of another illustration, the frame 611 may be processed to identify whether or not the text of the text element 621 is readable and/or accurate. Various configurations are possible and contemplated without departing from the scope of the present disclosure.

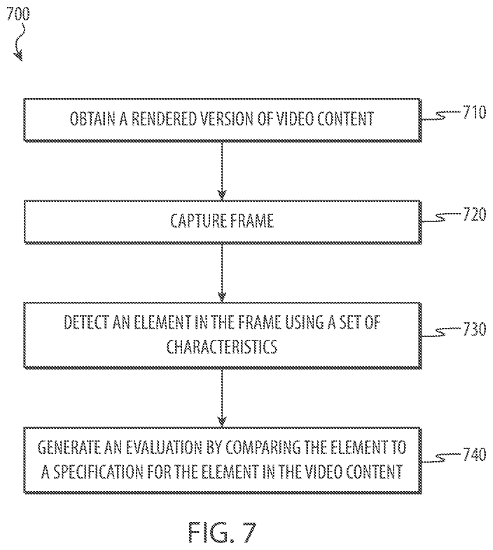

FIG. 7 depicts a flow chart illustrating a third example method 700 for artificial intelligence and machine learning evaluation of elements in rendered video. This method 700 may be performed by the system 100 of FIG. 1 and/or the video processing and evaluation device 201 of FIG. 2.

At operation 710, an electronic device (such as the video processing and evaluation device 101, 201 of FIGS. 1 and/or 2) may obtain a rendered version of video content. At operation 720, the electronic device may capture a frame and/or other portion of the rendered version of video content. At operation 730, the electronic device may detect an element in the frame using a set of characteristics. The set of characteristics may be usable to distinguish the element from one or more other elements.

For example, a set of characteristics may be usable to distinguish a text element (such as a closed captioning element, a subtitle element, a cell of an electronic programming guide, and so on) from other elements, such as a channel or network logo, an icon, and so on. Such a set of characteristics may specify that the text element typically includes a rectangle polygon element, includes text, has multiple corners, cannot be broken down into smaller rectangles whereas other elements may include multiple corners and can be broken down into smaller rectangles and/or other polygons, is positioned at the bottom center and/or other position on the screen as opposed to other elements that may appear anywhere, changes every ten seconds and/or other time period associated with reading speed, includes a single background color (such as black), includes text of a contrasting color compared to that of a background color (such as the color of white in a tool like Chroma), the color of the text element holds consistent while the background around the text element in the frame changes, and so on.

At operation 740, the electronic device may generate an evaluation by comparing the element to a specification for the element in the video content. The evaluation may score how closely the element adheres to the specification for the element in the video content.

In various examples, this example method 700 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 700 is illustrated and described as including particular operations performed in a particular order, it is understood that this is an example. In various implementations, various orders of the same, similar, and/or different operations may be performed without departing from the scope of the present disclosure.

For example, operation 740 is illustrated and described as comparing the element to a specification for the element in the video content. However, it is understood that this is an example. In various implementations, the evaluation may involve comparison of various elements to one or more specifications. Additionally and/or alternatively, in some implementations, the evaluation may compare the element to the code and/or other instructions in the video content as opposed to a specification. Various configurations are possible and contemplated without departing from the scope of the present disclosure.

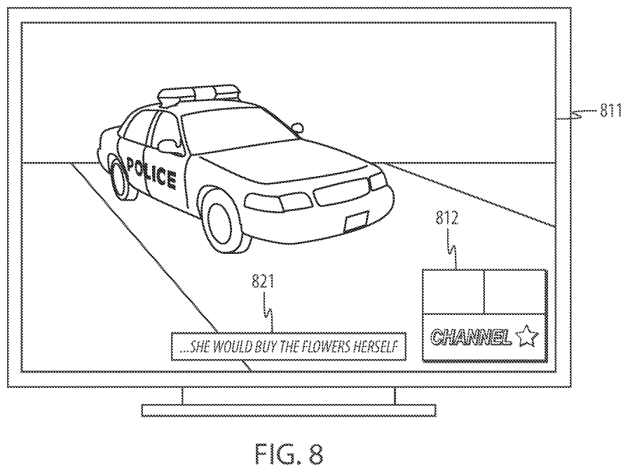

FIG. 8 depicts a third example frame 811 of video content. The frame 811 may include a channel logo 812 and a text element 821 (such as a closed captioning element, a subtitle element, and so on). The methods 300, 400 of FIGS. 3-4 (and/or one or more of the other methods discussed herein) may be used to process the frame 811 to identify one or more of the channel logo 812 and/or the text element 821, distinguish the channel logo 812 from the text element 821, and/or generate one or more evaluations.

By way of illustration, the frame 811 may be processed to distinguish the channel logo 812 from the text element 821 using a set of characteristics that distinguishes one or more of the channel logo 812 and the text element 821 from each other and/or other elements. For example, the set of characteristics may indicate that the channel logo 812 is intended to be positioned at the bottom right of the frame 811 whereas the text element 821 is intended to be positioned at the middle right of the frame 811. By way of another example, the set of characteristics may indicate that the text element 821 typically includes a rectangle polygon element, includes text, has corners, cannot be broken down into smaller rectangles, is positioned at the bottom center and/or other position on the screen, changes every ten seconds and/or other time period associated with reading speed, includes a single background color, includes text of a contrasting color compared to that of a background color, and so on. By way of still another example, the set of characteristics may indicate that the text element 821 includes a rectangle polygon element that has text, corners, and cannot be broken down into smaller rectangles whereas the channel logo 812 includes a rectangle polygon element that has text, corners, and can be broken down into smaller rectangles. An electronic device may use such a set of characteristic as performing one or more of the methods 300, 400 of FIGS. 3-4 (and/or one or more of the other methods discussed herein) to process the frame 811 to distinguish the channel logo 812 from the text element 821 and/or to perform other operations. However, it is understood that this is an example and that other configurations are possible and contemplated without departing from the scope of the present disclosure.

By way of another illustration, the frame 811 may be processed to identify whether or not the text of the text element 821 is readable and/or accurate. Various configurations are possible and contemplated without departing from the scope of the present disclosure.

Text elements, such as Title 6 closed captioning, may be required by the Federal Communication Commission for the hearing impaired. Title 6 closed captioning may typically be rendered on a screen or other display as white text on a black background inside a rectangle or other polygon. Such characteristics may be included in a set of characteristics that may be used with the techniques of the present disclosure to identify, detect, and/or distinguish Title 6 closed captioning text elements (and/or other text elements, such as subtitle elements, electronic program guide cells, and so on), electronic programming guide cells, and so on) from other elements. Such identification, detection, and/or distinguishing may be used to generate evaluations of text elements in the video content, such as whether or not the text elements are present, located where and when intended in the video content, accurate, readable, and so on.

For example, tools like OpenCV tools and Magewell Capture cards may be used to capture one or more images of rendered video content including rendered closed captioning elements, identify the unique block of the closed captioning element by its polygon, mask the polygon (eliminating other elements of the video content), isolate by image capturing this masked polygon, apply optical character recognition (OCR) to this polygon to extrapolate the text, compare the extrapolated text (whether by individual words, phrases, the text of the entire closed captioning element, and so on) to a reference (such as the closed captioning data included in the video content or obtained elsewhere, extrapolated closed captioning data, a dictionary, or a library, a full listing of the text included in the closed captioning data, a transcript of the video content, and so on), and/or derive a confidence score.

Such a confidence score may evaluate whether or not the closed captioning element is accurate and/or readable. For example, a font size of the text may be determined and scored for readability based on various factors, such as whether the font is a sufficient size and clarity to be viewed by people with between 20/10-20/40 visual acuity at a distance of approximately 1-20 feet, and/or accurate, and so on. By way of another example, an accuracy score may be determined based on how closely the text adheres to closed captioning data included in the video content or obtained elsewhere, how closely the text adheres to a full listing of the text included in the closed captioning data, a transcript of the video content, whether or not the text includes words listed in a dictionary, whether or not a grammar checker indicates that the words of the text belong together, and so on. By way of yet another example, OCR may be configured to optically recognize text at various levels of readability (such as whether or not readable when viewed by people with between 20/10-20/40 visual acuity at a distance of approximately 1-20 feet). As such, the readability score may be influenced by configuring the OCR to recognize text at various levels so that the text is less accurately recognized when less readable and more accurately recognized as more readable, which may then be reflected in the accuracy score. Various configurations are possible and contemplated without departing from the scope of the present disclosure.

In some examples, such a confidence score may be generated by creating a validation file from the closed captioning data stream. The text extracted from the closed captioning element using OCR may be compared to the known or expected closed captioning data in the validation file. Scoring may be a percentage of incorrectly defined (mis-rendered) characters from the OCR to the valid data. In examples where the closed captioning data steam may not be extrapolated, the text extracted from the closed captioning element using OCR may be validated against a dictionary of words to determine their readability score.

Although FIG. 8 illustrates detection of closed captioning text elements, it is understood that this is an example. The present techniques may be applied to any kind of text element, such as subtitles, cells of an electronic programming guide, a menu, a user interface, and so on without departing from the scope of the present disclosure.

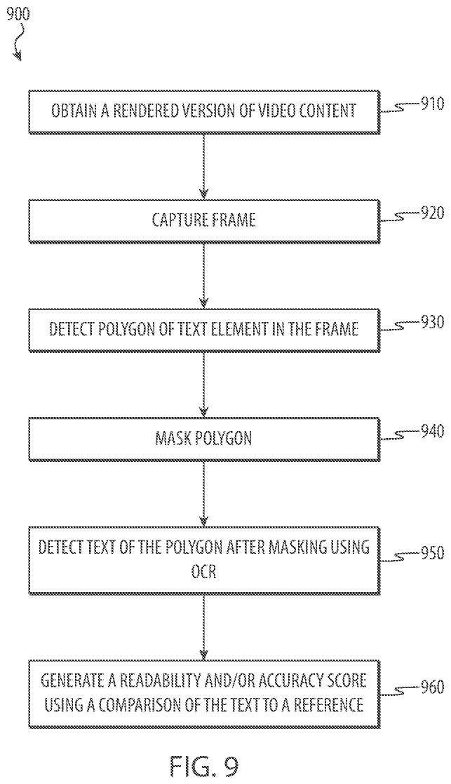

FIG. 9 depicts a flow chart illustrating a fourth example method 900 for artificial intelligence and machine learning evaluation of elements in rendered video. This method 900 may be performed by the system 100 of FIG. 1 and/or the video processing and evaluation device 201 of FIG. 2.

At operation 910, an electronic device (such as the video processing and evaluation device 101, 201 of FIGS. 1 and/or 2) may obtain a rendered version of video content. At operation 920, the electronic device may capture a frame of the rendered version of the video content.

At operation 930, the electronic device may detect the polygon of a text element in the frame. At operation 940, the electronic device may mask the polygon. At operation 950, the electronic device may detect text of the polygon after masking using OCR.

At operation 960, the electronic device may generate a readability and/or accuracy score using a comparison of the text to a reference. The reference may be the closed captioning data included in the video content or obtained elsewhere, extrapolated closed captioning data, a dictionary, or a library, a full listing of the text included in the closed captioning data, a transcript of the video content, and so on.

For example, a font size of the text may be determined and scored for use in determining the readability and/or accuracy score based on various factors, such as whether the font is a sufficient size and clarity to be viewed by people with between 20/10-20/40 visual acuity at a distance of approximately 1-20 feet and/or accurate, and so on. By way of another example, the readability and/or accuracy score may be determined based on how closely the text adheres to closed captioning data included in the video content or obtained elsewhere, how closely the text adheres to a full listing of the text included in the closed captioning data, a transcript of the video content, whether or not the text includes words listed in a dictionary, whether or not a grammar checker indicates that the words of the text belong together, and so on. By way of yet another example, OCR may be configured to optically recognize text at various levels of readability (such as whether or not readable when viewed by people with between 20/10-20/40 visual acuity at a distance of approximately 1-20 feet). As such, the readability and/or accuracy score may be influenced by configuring the OCR to recognize text at various levels so that the text is less accurately recognized when less readable and more accurately recognized when more readable, which may then be reflected in the accuracy score. Various configurations are possible and contemplated without departing from the scope of the present disclosure.

In various examples, this example method 900 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as detecting a polygon of a text element, masking the polygon, and detecting text of the polygon after masking using OCR. However, it is understood that this is an example. Other procedures are possible and contemplated, such as without masking, without departing from the scope of the present disclosure.

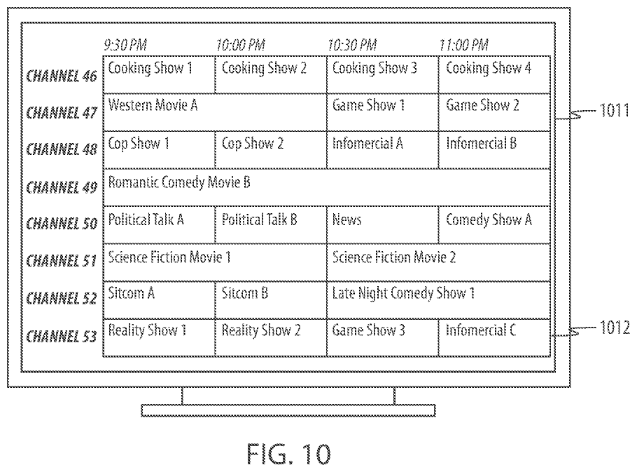

FIG. 10 depicts a fourth example frame 1011 of video content. The frame 1011 illustrates a program guide made up of a number of cells 1012 forming a grid. The methods 300, 400, 700, 900 of FIGS. 3-4, 7, and 9 (and/or one or more of the other methods discussed herein) may be used to process the frame 1011 to detect one or more of the cells 1012 and/or evaluate the accuracy and/or readability of the text of the cells 1012. Various configurations are possible and contemplated without departing from the scope of the present disclosure.

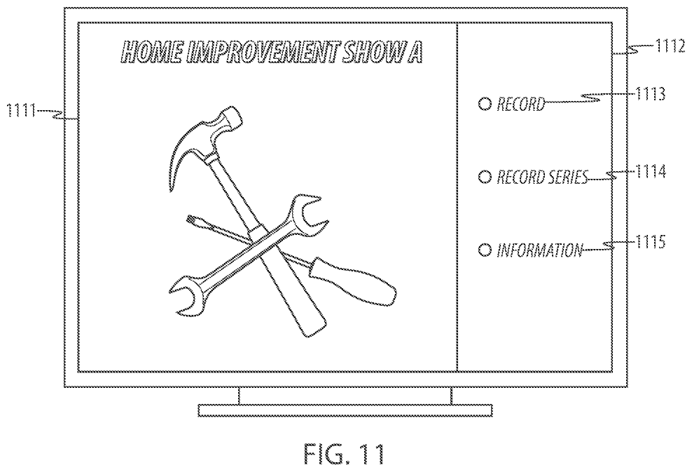

FIG. 11 depicts a fifth example frame 1111 of video content. The frame 1111 includes a user interface menu 1112 including a Record interactive element 1113, a Record Series interactive element 1114, and an Information interactive element 1115. The methods 300, 400, 700, 900 of FIGS. 3-4, 7, and 9 (and/or one or more of the other methods discussed herein) may be used to process the frame 1111 to detect one or more of the interactive elements of the user interface menu 1112 and/or evaluate the accuracy and/or readability of the text of the interactive elements of the user interface menu 1112. The methods 300, 400, 700, 900 of FIGS. 3-4, 7, and 9 (and/or one or more of the other methods discussed herein) may also be used to process the frame 1111 to evaluate the position of the interactive elements of the user interface menu 1112 in time or space of the video content, the rendered appearance of the interactive elements of the user interface menu 1112, and so on. Various configurations are possible and contemplated without departing from the scope of the present disclosure.

Additionally, the techniques of the present disclosure may be used to evaluate a number of other aspects of elements in rendered video content. For example, the techniques of the present disclosure may be used to locate elements such as logos and icons and/or evaluate whether or not such are where they are intended to be in time and/or space with respect to video content, distinguish between commercials and programs, verify icon and/or other element placement, evaluate video quality, and so on.

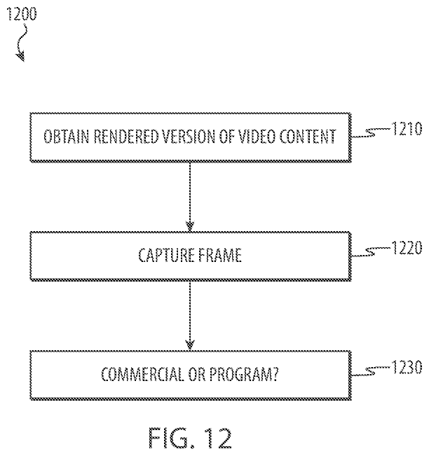

FIG. 12 depicts a flow chart illustrating a fifth example method 1200 for artificial intelligence and machine learning evaluation of elements in rendered video. This method 1200 may be performed by the system 100 of FIG. 1 and/or the video processing and evaluation device 201 of FIG. 2.

At operation 1210, an electronic device (such as the video processing and evaluation device 101, 201 of FIGS. 1 and/or 2) may obtain a rendered version of video content. At operation 1220, the electronic device may capture one or more frames of the video content. At operation 1230, the electronic device may determine whether the one or more frames are associated with a commercial or a program.

For example, the electronic device may attempt to locate a channel and/or network logo or icon and/or other element that appears for an extended period of time, such as in a lower corner, in the one or more frames. Further, the electronic device may attempt to locate one or more closed captioning or subtitle elements, such as in the bottom or top middle, in the one or more frames. Presence of a channel and/or network logo or icon and/or other element and/or a closed captioning or subtitle element (such as is shown in FIGS. 6 and 8) may indicate that the one or more frames correspond to a program as opposed to a commercial. Conversely, absence of a channel and/or network logo or icon and/or other element and/or a closed captioning or subtitle element may indicate that the one or more frames correspond to a commercial as opposed to a program. Various configurations are possible and contemplated without departing from the scope of the present disclosure.

By way of another example, the electronic device may attempt to locate one or more other elements of features, such as multiple frames of black video. Multiple frames of black video may indicate a transition between a program and a commercial. However, it is understood that this is an example. In various implementations, the electronic device may perform commercial detection using other techniques without departing from the scope of the present disclosure. Various configurations are possible and contemplated without departing from the scope of the present disclosure.

In various examples, this example method 1200 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 1200 is illustrated and described as including particular operations performed in a particular order, it is understood that this is an example. In various implementations, various orders of the same, similar, and/or different operations may be performed without departing from the scope of the present disclosure.

For example, the method 1200 is illustrated and described in the context of distinguishing between commercials and programs. However, it is understood that this is an example. In various implementations, the method 1200 may be used to determine a channel and/or network associated with the video content. In some examples, this may be done by locating and/or identifying a channel and/or network logo or icon and/or other element in the one or more frames. Various configurations are possible and contemplated without departing from the scope of the present disclosure.

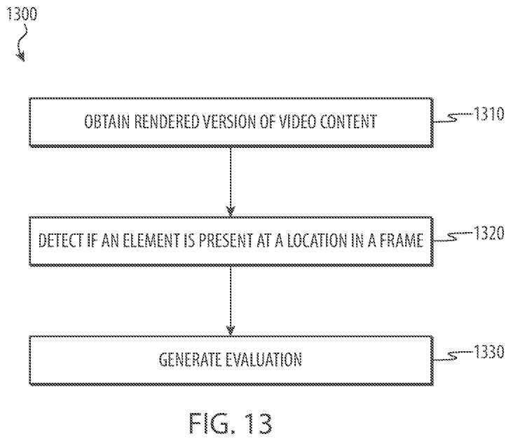

FIG. 13 depicts a flow chart illustrating a sixth example method 1300 for artificial intelligence and machine learning evaluation of elements in rendered video. This method 1300 may be performed by the system 100 of FIG. 1 and/or the video processing and evaluation device 201 of FIG. 2.

At operation 1310, an electronic device (such as the video processing and evaluation device 101, 201 of FIGS. 1 and/or 2) may obtain a rendered version of video content. At operation 1320, the electronic device may detect if an element is present at a location in a frame. At operation 1330, the electronic device may generate an evaluation.

For example, the electronic device may detect whether or not the Record interactive element 1113 is present at a specified location in the frame 1111. The electronic device may generate an evaluation accordingly based on whether or not the electronic device detected the Record interactive element 1113 as present at the specified location in the frame 1111.

In various examples, this example method 1300 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 1300 is illustrated and described as including particular operations performed in a particular order, it is understood that this is an example. In various implementations, various orders of the same, similar, and/or different operations may be performed without departing from the scope of the present disclosure.

For example, the method 1300 is illustrated and described as detecting whether or not an element, such as the Record interactive element 1113, is present. However, it is understood that this is an example. In some implementations, these techniques may be used to verify that one or more particular commercials are present at specified times in the video content, for specified durations, and so on. Various configurations are possible and contemplated without departing from the scope of the present disclosure.

As mentioned above, the present techniques may be used to evaluate video quality, which may be related to compression. For example, the present techniques may be used to evaluate a video mean opinion score and/or other measurements of video quality. As televisions and/or other display and/or output devices become larger and/or increase in resolution, they may reveal more flaws in video content as such flaws may be spread over more pixels and/or similar elements. Compression algorithms may be used to reduce bandwidth required, though this may reduce the original quality and balance quality for bandwidth. Content providers do not typically transmit full frame uncompressed (raw) video outside of the studio, instead compressing in one way or another. Video content may be evaluated to ensure that this compression does not result in visible compression artifacts. However, it may be extremely burdensome, expensive, and/or time consuming to evaluate all video content. Further, automated comparison may require copies of both the video content and the uncompressed source in order to compare. The present techniques may enable evaluation using artificial intelligence and machine learning as opposed to human beings watching the video content and may eliminate the need for copies of both the video content and the uncompressed source in order to compare.

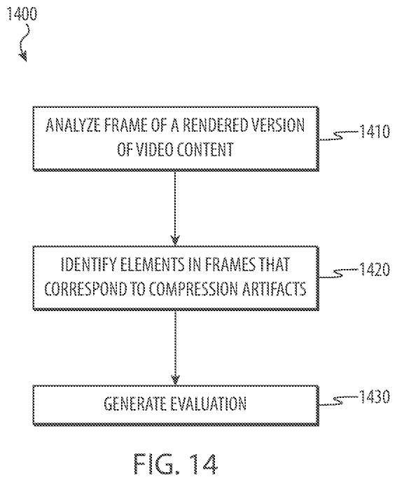

FIG. 14 depicts a flow chart illustrating a seventh example method 1400 for artificial intelligence and machine learning evaluation of elements in rendered video. This method 1400 may be performed by the system 100 of FIG. 1 and/or the video processing and evaluation device 201 of FIG. 2.

At operation 1410, an electronic device (such as the video processing and evaluation device 101, 201 of FIGS. 1 and/or 2) may analyze frames of a rendered version of video content. At operation 1420, the electronic device may identify elements in frames that correspond to compression artifacts.

For example, the electronic device may identify areas of high compression (which may be identifiable from coarse images) in the rendered video content. By way of another example, the electronic device may identify areas in the rendered video content where dropped video packets occurred, such as by identifying macro blocking (a video artifact in which objects or areas of a video image appear to be made up of small squares, rather than proper detail and smooth edges) or pixilation, micro blocking, and so on. By way of still another example, the electronic device may identify video upscaling artifacts in the rendered video content. By way of yet another example, the electronic device may identify video freezing artifacts in the rendered video content.

By way of illustration, tools (such as OpenCV) may be used by an electronic device to capture multiple full screen images from the rendered video content. Tools (such as Chroma, Gamut, and so on) may be used by an electronic device to analyze areas in one or more of the multiple full screen images (such as pixel by pixel, micro block by micro block less than 2×2, micro block by micro block less than 4×4, and so on). The electronic device may look for and measure the delta (change) between adjacent areas. These deltas may represent sharp edges where smooth transitions do not exist. The electronic device may map these transitions to leave a histogram that may show where compression made the most changes.

At operation 1430, the electronic device may generate an evaluation. The evaluation may be based on the identified elements that correspond to compression artifacts. The electronic device may provide alarms for one or more video events, provide one or more ratings scores, and/or use such data to adjust (and/or signal one or more other devices to adjust) the video content and/or one or more processes and/or devices used to generate the video content. For example, the electronic device may adjust (and/or signal one or more other devices to adjust) the compression level used to reduce bandwidth of the rendered video content so that bandwidth reduction is achieved without sacrificing visual quality.

In various examples, this example method 1400 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 1400 is illustrated and described as including particular operations performed in a particular order, it is understood that this is an example. In various implementations, various orders of the same, similar, and/or different operations may be performed without departing from the scope of the present disclosure.

For example, the method 1400 is illustrated and described in the context of identifying elements corresponding to compression artifacts. However, it is understood that this is an example. In other implementations, other elements and/or events not corresponding to compression artifacts may be identified. For example, high quality areas may be identified and evaluated to determine video quality as opposed to compression artifacts. Various configurations are possible and contemplated without departing from the scope of the present disclosure.

By way of another illustration, the electronic device may instead detect paused or buffering video instead of, and/or in addition to, identifying elements corresponding to compression artifacts. For example, the electronic device may detect paused or buffering video by locating multiple frames of captured video that do not change. This may be measured and expressed in a value of time. For example, a buffering stream may cause a video decoder to hold a single frame of rendered video until the video decoder is able to resume rendering video. The electronic device may calculate the number of frames captured per second that do not change and present a paused or buffering video event. In some examples, the duration of the event may also be presented. Various configurations are possible and contemplated without departing from the scope of the present disclosure.

In yet another illustration, the electronic device may detect channel disruptions. For example, channel disruptions may result in a slate (i.e., a notice board, clapperboard, clapboard, markers, slate boards, sync slate, and so on used to display information presented as text related to video, such as a scene number and take number, that may be used for organizing footage. The electronic device may detect the slate presented with text, read the text with OCR, and present a channel disruption event with the captured text. By way of example, channel disruption events resulting in a slate presented with text may include a channel being blacked out due to content restrictions, content blocked due to carrier restrictions, indications of network streaming issues, and so on. Various configurations are possible and contemplated without departing from the scope of the present disclosure.

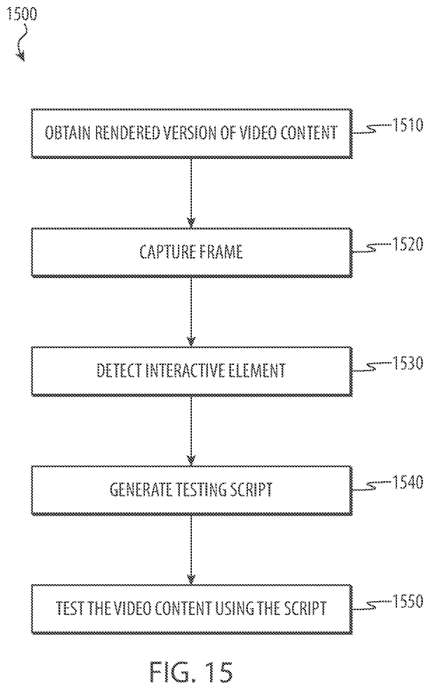

FIG. 15 depicts a flow chart illustrating an eighth example method 1500 for artificial intelligence and machine learning evaluation of elements in rendered video. This method 1500 may be performed by the system 100 of FIG. 1 and/or the video processing and evaluation device 201 of FIG. 2.

At operation 1510, an electronic device (such as the video processing and evaluation device 101, 201 of FIGS. 1 and/or 2) may obtain a rendered version of video content. At operation 1520, the electronic device may capture one or more frames of the rendered version of the video content. At operation 1530, the electronic device may detect one or more interactive elements in the one or more frames. At operation 1540, a testing script may be generated using one or more of the detected interactive elements. At operation 1550, the video content may be tested using the testing script.

For example, the method 1500 may be performed on the frame 511 of FIG. 5. Performing the method 1500 on the frame 511 may detect interactive elements 512 including the search element 513, the rewind element 514, the pause element 515, and the cue element 516. A testing script may be generated using one or more of the search element 513, the rewind element 514, the pause element 515, and the cue element 516. The testing script may then be tested on the video content associated with the frame 511.

In various examples, this example method 1500 may be implemented as a group of interrelated software modules or components that perform various functions discussed herein. These software modules or components may be executed within a cloud network and/or by one or more computing devices, such as the video processing and evaluation device 101, 201 of FIGS. 1 and/or 2.

Although the example method 1500 is illustrated and described as including particular operations performed in a particular order, it is understood that this is an example. In various implementations, various orders of the same, similar, and/or different operations may be performed without departing from the scope of the present disclosure.

For example, the method 1500 is illustrated and described as including the operations 1540 and 1550. However, it is understood that this is an example. In various implementations, one or more of these operations may be omitted. Various configurations are possible and contemplated without departing from the scope of the present disclosure.

Although the above illustrates and describes a number of embodiments, it is understood that these are examples. In various implementations, various techniques of individual embodiments may be combined without departing from the scope of the present disclosure.

In various implementations, a method for evaluating video content may include obtaining a rendered version of the video content using a processor, capturing a frame of the rendered version of the video content using the processor, detecting a polygon of a text element in the frame using the processor, masking the polygon using the processor, detecting text of the polygon after the masking using the processor via optical character recognition, and generating a readability and accuracy score for the text using the processor using a comparison of the text to a reference. In some examples, detecting the polygon of the text element in the frame using the processor may include determining whether the polygon includes a single color background.

In a number of examples, detecting the polygon of the text element in the frame using the processor may include determining whether the polygon includes contrasting text color inside the polygon. In various examples, detecting the polygon of the text element in the frame using the processor may include determining whether a color of the polygon holds consistent while a background changes. In some examples, detecting the polygon of the text element in the frame using the processor may include evaluating a position of the polygon in the frame. In a number of examples, detecting the polygon of the text element in the frame using the processor may include determining whether the polygon is a rectangle that includes multiple rectangles.

In various examples, the text element may be at least one of a closed captioning element, a subtitle element, or an electronic program guide element. In some examples, the reference may be at least one of closed captioning data associated with the video content, a library, or a dictionary. In a number of examples, the readability and accuracy score may be based at least on one of a percentage of incorrectly defined characters or a font size.

In some implementations, a method for evaluating video content may include obtaining a rendered version of the video content using a processor, capturing a frame of the rendered version of the video content using the processor, detecting an element in the frame using the processor using a set of characteristics that distinguishes the element from other elements, and generating an evaluation using the processor by comparing the element detected in the frame to a specification for the element in the video content. In various examples, the rendered version of the video content may be obtained via a video capture card.

In a number of examples, the method may further include using the element to determine a channel associated with the frame. In some examples, the method may further include using the element to determine that the frame is associated with a commercial. In a number of such examples, the element may be at least one of a channel logo, a network logo, or a closed captioning element.

In various examples, the evaluation may include placement of an icon or a logo. In a number of examples, the evaluation may indicate a video quality resulting from compression. In various examples, the rendered version of the video content may be obtained via an image sensor.

In a number of implementations, a method for evaluating video content may include obtaining a rendered version of the video content using a processor, capturing a frame of the rendered version of the video content using the processor, and detecting an interactive element in the frame using the processor using a set of characteristics that distinguishes the interactive element from other elements. In some examples, the method may further include generating a testing script using the interactive element detected in the frame. In various implementations of such examples, the method may further include testing the video content using the testing script.

As described above and illustrated in the accompanying figures, the present disclosure relates to using artificial intelligence and machine learning to more accurately identify elements in presented video content. In some examples, tools may be used to interrogate back end code to find interactive elements as opposed to on-screen display. This may find what is intended to be present rather than what actually ends up being present, which may not be the same. The code may specify to generate interactive elements that do not get generated and are thus irrelevant because they cannot actually be seen and/or interacted with. Instead, actual on-screen display may be analyzed to visually and/or conceptually recognize interactive elements in the on-screen display. In some examples, a capture card may be used to locally interrogate a video signal. Artificial intelligence/machine learning may then be used to process the locally captured video signal in order to recognize what is actually on the screen and enhance that recognition with artificial intelligence/machine learning. A camera may capture the screen instead, though screen capture eliminates the possibility of glare. This may be used to evaluate aspects of generated video, such as the quality of closed captioning or subtitles, an electronic programming guide, video (artifacts from compression), and so on. This may also be done to identify interactive elements to have automation testing interact with when designing automation testing scripts.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A method for evaluating video content, comprising:
obtaining a rendered version of the video content using a processor;
capturing a frame of the rendered version of the video content using the processor;
detecting a polygon of a text element in the frame using the processor;
masking the polygon using the processor;
detecting text of the polygon after the masking using the processor via optical character recognition; and
generating a readability and accuracy score for the text using the processor using a comparison of the text to a reference, the readability and accuracy score including a readability component that is based at least on a font size of the text detected in the rendered version of the video content.

2. The method of claim 1, wherein detecting the polygon of the text element in the frame using the processor comprises determining whether the polygon includes a single color background.

3. The method of claim 1, wherein detecting the polygon of the text element in the frame using the processor comprises determining whether the polygon includes contrasting text color inside the polygon.

4. The method of claim 1, wherein detecting the polygon of the text element in the frame using the processor comprises determining whether a color of the polygon holds consistent while a background changes.

5. The method of claim 1, wherein detecting the polygon of the text element in the frame using the processor comprises evaluating a position of the polygon in the frame.

6. The method of claim 1, wherein detecting the polygon of the text element in the frame using the processor comprises determining whether the polygon is a rectangle that includes multiple rectangles.

7. The method of claim 1, wherein the text element comprises at least one of a closed captioning element, a subtitle element, or an electronic program guide element.

8. The method of claim 1, wherein the reference comprises at least one of closed captioning data associated with the video content, a library, or a dictionary.

9. The method of claim 1, wherein the readability and accuracy score is based at least on a percentage of incorrectly defined characters.

10. A method for evaluating video content, comprising:
obtaining a rendered version of the video content using a processor;
capturing a frame of the rendered version of the video content using the processor;
detecting an element in the frame using the processor using a set of characteristics that distinguishes the element from other elements; and
generating an evaluation using the processor by comparing the element detected in the frame to a specification for the element in the video content that specifies a time the element is in the video content.

11. The method of claim 10, wherein the rendered version of the video content is obtained via a video capture card.

12. The method of claim 10, further comprising using the element to determine a channel associated with the frame.

13. The method of claim 10, further comprising using the element to determine that the frame is associated with a commercial.

14. The method of claim 10, wherein the element comprises at least one of a channel logo, a network logo, or a closed captioning element.

15. The method of claim 10, wherein the evaluation includes placement of an icon or a logo.

16. The method of claim 10, wherein the evaluation indicates a video quality resulting from compression.

17. The method of claim 10, wherein the rendered version of the video content is obtained via an image sensor.

18. A method for evaluating video content, comprising:
obtaining a rendered version of the video content using a processor;
capturing a frame of the rendered version of the video content using the processor;
detecting an interactive element in the frame using the processor using a set of characteristics that distinguishes the interactive element from other elements; and
generating a new testing script specifically for the interactive element detected in the frame using the interactive element detected in the frame.

19. The method of claim 18, wherein the interactive element comprises at least one of a search element, a rewind element, a pause element, or a cue element.

20. The method of claim 19, further comprising testing the video content using the new testing script.
